(19) United States
(12) Patent Application Publication
(10) Pub. No.: US 2024/0176992 A1
(43) Pub. Date: May 30, 2024

(54) METHOD, APPARATUS AND DEVICE FOR EXPLAINING MODEL AND COMPUTER STORAGE MEDIUM

(71) Applicant: BOE Technology Group Co., Ltd., Beijing (CN)

(72) Inventor: Yusi CHEN, Beijing (CN)

(73) Assignee: BOE Technology Group Co., Ltd., Beijing (CN)

(21) Appl. No.: 18/577,739

(22) PCT Filed: Nov. 1, 2022
(86) PCT No.: PCT/CN2022/128903

§ 371 Date: Jan. 9, 2024

(51) Int. Cl. G06N 3/0455; G06N 3/08

(52) U.S. Cl. CPC G06N 3/0455; G06N 3/08

(57) ABSTRACT

Disclosed is a method for explaining a model. The method comprises: transforming a target input sample from an original feature space to an embedding space; generating a perturbation data set in the embedding space; acquiring a weight of a neighborhood vector in the perturbation data set; after that, transforming the perturbation data set back to the original feature space; acquiring an explainable model of a target data analysis model by training based on the acquired data; and acquiring an explanation result based on the explainable model.

### CROSS-REFERENCE TO RELATED APPLICATION

This application is a U.S. national phase application based on PCT/CN2022/128903, filed on Nov. 1, 2022, the content of which is incorporated herein by reference in its entirety.

### TECHNICAL FIELD

The present disclosure relates to the field of computer technologies, and in particular to a method, apparatus and device for explaining a model, and a computer storage medium.

### BACKGROUND

A data analysis model is a model that can analyze various features of an object and output an analysis result. A method for explaining a model is to determine the weight of each feature in a sample (the sample can include multiple features of the object) input into the data analysis model.

### SUMMARY

Embodiments of the present disclosure provide a method, apparatus and device for explaining a model, and a computer storage medium. The technical solutions are described as below.

According to a first aspect of the present disclosure, a method for explaining a model is provided. The method includes:
acquiring a target input sample of a target data analysis model, the target input sample including a plurality of features;
acquiring an embedding vector by transforming the target input sample from an original feature space to an embedding space, the original feature space being a feature space where the target input sample is disposed;
generating a neighborhood perturbation data set based on the embedding vector, the neighborhood perturbation data set including a plurality of first neighborhood vectors in a neighborhood of the embedding vector;
determining a weight of each of the first neighborhood vectors based on a distance between the first neighborhood vector and the embedding vector, the distance being negatively correlated with the weight of the first neighborhood vector;
acquiring an original perturbation data set by transforming the neighborhood perturbation data set into the original feature space, the original perturbation data set including a plurality of second neighborhood vectors;
acquiring a plurality of output vectors by inputting the plurality of second neighborhood vectors into the target data analysis model;
acquiring an explainable model by training a to-be-trained explainable model, by taking the plurality of second neighborhood vectors, the plurality of output vectors, and the weight of each of the first neighborhood vectors as training samples; and
acquiring, based on the explainable model, weights of the plurality of features in the target input sample.

Optionally, acquiring the embedding vector by transforming the target input sample from the original feature space to the embedding space includes:
inputting the target input sample into an encoder in an autoencoder, and transforming the target input sample into the embedding vector by the encoder, wherein the autoencoder includes the encoder and a decoder.

Optionally, acquiring the original perturbation data set by transforming the neighborhood perturbation data set into the original feature space includes:
inputting the neighborhood perturbation data set into the decoder in the autoencoder, and transforming the neighborhood perturbation data set into the original perturbation data set by the decoder.

Optionally, prior to inputting the target input sample into the encoder in the autoencoder, and transforming the target input sample into the embedding vector by the encoder, the method further includes:
acquiring a data set of the target data analysis model, the data set including a plurality of training samples and labels corresponding to the training samples;
acquiring a trained neural network by training, based on the training sample of the target data analysis model, a to-be-trained neural network, the to-be-trained neural network including an input layer and an entity embedding layer connected to the input layer; and
determining an embedding matrix between the input layer and the entity embedding layer in the trained neural network as the encoder.

Optionally, the embedding matrix is configured to transform an input feature into a real-valued dense feature.

Optionally, upon determining the embedding matrix between the input layer and the entity embedding layer in the trained neural network as the encoder, the method further includes:
training, by the encoder, a to-be-trained decoder, such that the decoder is capable of transforming a vector transformed into the embedding space by the encoder back to the original feature space.

Optionally, prior to acquiring the trained neural network by training, based on the training sample of the target data analysis model, the to-be-trained neural network, the method further includes:
transforming, in a case that the training sample in the data set of the target data analysis model includes a non-numerical feature, the non-numerical feature into a one-hot code.

Optionally, the explainable model is one of a linear model, a decision-making tree, or a descent rule list model.

Optionally, acquiring, based on the explainable model, the weights of the plurality of features in the target input sample includes:
acquiring, in a case that the explainable model is a linear model, coefficients of the plurality of features in the explainable model; and
determining the coefficients of the plurality of features as weights of the plurality of features.

Optionally, acquiring the explainable model by training the to-be-trained explainable model, by taking the plurality of second neighborhood vectors, the plurality of output vectors, and the weight of each of the first neighborhood vectors as the training samples, includes:
training the to-be-trained explainable model, by taking the plurality of second neighborhood vectors, the plurality of output vectors, and the weight of each of the first neighborhood vectors as training samples; and
determining, in a case that approximate values of decisions of the to-be-trained explainable model and the target data analysis model are greater than or equal to a preset decision value, the to-be-trained explainable model as the explainable model.

Optionally, upon acquiring, based on the explainable model, the weights of the plurality of features in the target input sample, the method further includes:
optimizing the target data analysis model based on the weights of the plurality of features.

Optionally, the target input sample includes a plurality of features of an object; and
the target data analysis model is a prediction model for the object, or the target data analysis model is a classification model for the object.

Optionally, the object includes a user, an animal, or an item.

According to another aspect of the present disclosure, an apparatus for explaining a model is provided. The apparatus for explaining the model includes:
a sample acquiring module, configured to acquire a target input sample of a target data analysis model, the target input sample including a plurality of features;
a first transforming module, configured to acquire an embedding vector by transforming the target input sample from an original feature space to an embedding space, the original feature space being a feature space where the target input sample is disposed;
a perturbation generating module, configured to generate a neighborhood perturbation data set based on the embedding vector, the neighborhood perturbation data set including a plurality of first neighborhood vectors in a neighborhood of the embedding vector;
a weight determining module, configured to determine a weight of each of the first neighborhood vectors based on a distance between the first neighborhood vectors and the embedding vector, the distance being negatively correlated with the weight of the first neighborhood vector;
a second transforming module, configured to acquire an original perturbation data set by transforming the neighborhood perturbation data set into the original feature space, the original perturbation data set including a plurality of second neighborhood vectors;
an inputting module, configured to acquire a plurality of output vectors by inputting the plurality of second neighborhood vectors into the target data analysis model;
a first training module, configured to acquire an explainable model by training a to-be-trained explainable model, by taking the plurality of second neighborhood vectors, the plurality of output vectors, and the weights of each of the first neighborhood vectors as training samples; and
an explaining module, configured to acquire, based on the explainable model, weights of the plurality of features in the target input sample.

Optionally, the first transforming module is configured to input the target input sample into an encoder in an autoencoder, and transform the target input sample into the embedding vector by the encoder; and
the second transforming module is configured to input the neighborhood perturbation data set into a decoder in the autoencoder, and transform the neighborhood perturbation data set into the original perturbation data set by the decoder.

Optionally, the apparatus for explaining the model further includes:
a data set acquiring module, configured to acquire a data set of the target data analysis model, the data set including a plurality of training samples and labels corresponding to the training samples;
a second training module, configured to acquire a trained neural network by training, based on the training sample of the target data analysis model, a to-be-trained neural network, the to-be-trained neural network including an input layer and an entity embedding layer connected to the input layer; and
an encoder determining module, configured to determine an embedding matrix between the input layer and the entity embedding layer in the trained neural network as the encoder.

According to yet another aspect of the embodiments of the present disclosure, a device for explaining a model is provided. The device for explaining the model includes a processor and a memory storing at least one instruction, at least one program, a code set, or an instruction set, wherein the at least one instruction, the at least one program, the code set, or the instruction set, when loaded and executed by the processor, causes the processor to perform the method for explaining the model described above.

According to still another aspect of the embodiments of the present disclosure, a computer storage medium is provided. The computer storage medium stores at least one instruction, at least one program, a code set, or an instruction set, wherein the at least one instruction, the at least one program, the code set, or the instruction set, when loaded and executed by a processor, causes the processor to perform the method for explaining the model described above.

According to yet still another aspect of the embodiments of the present disclosure, a computer program product or a computer program is provided. The computer program product or the computer program includes at least one computer instruction, the at least one computer instruction being stored in a computer-readable storage medium. A processor of a computer device reads the at least one computer instruction from the computer-readable storage medium, and the processor executes the at least one computer instruction to cause the computer device to perform the method for explaining the model described above.

The technical solutions provided by the embodiments of the present disclosure at least achieve the following beneficial effects.

A target input sample is transformed from an original feature space to an embedding space, perturbation data set is generated in the embedding space, and weights of neighborhood vectors in the perturbation data set are acquired. After that, the perturbation data set can be transformed back to the original feature space, an explainable model of a target data analysis model can be acquired by training based on the acquired data, and an explanation result can be acquired based on the explainable model. By establishing one explainable model related to the to-be-explained data analysis model, the method can explain a black-box model that is complicated in structure, which solves the problem of low practicability of a method for explaining a model in the related art, and achieves the effect of improving the practicability of the method for explaining the model.

In addition, in the present disclosure, the perturbation data set is generated in the embedding space, the weights are acquired correspondingly, and the perturbation data set is then transformed into the original feature space to train the explainable model. Since the embedding space can resist randomness of perturbation, the method can solve the problem of poor stability in the related art and achieve the effect of improving the stability of the method for explaining the model.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flow chart of a method for explaining a model according to some embodiments of the present disclosure;

FIG. 2 is a flow chart of another method for explaining a model according to some embodiments of the present disclosure;

FIG. 3 is a schematic structural diagram of a to-be-trained neural network according to some embodiments of the present disclosure;

FIG. 4 is a schematic structural diagram of an encoder and a decoder according to some embodiments of the present disclosure; and

FIG. 5 is a block diagram of an apparatus for explaining a model according to some embodiments of the present disclosure.

Explicit embodiments of the present disclosure have been shown by the drawings above and will be described in more detail later. These drawings or textual descriptions are not intended in any way to limit the scope of the concept of the present disclosure, but to explain the concept of the present disclosure for those skilled in the art by reference to specific embodiments.

### DETAILED DESCRIPTION

For clearer descriptions of the objectives, technical solutions, and advantages of the present disclosure, embodiments of the present disclosure are described in detail hereinafter with reference to the accompanying drawings.

In the related art, in a method for explaining a model, firstly, a to-be-explained model is acquired, and then the type of the to-be-explained model is determined. In the case that the to-be-explained model is an explainable model (a model that is simple in structure and easy to understand), the structure of the to-be-explained model is analyzed to determine the weight of each parameter in an input sample of the to-be-explained model.

The method described above can only explain the explainable model with a simple structure, however, models that are extensively applied currently are all black-box models with complicated structures (models that are complicated in structure and difficult to understand directly), which in turn leads to low practicability of the method described above.

The method provided by the embodiments of the present disclosure may be applied to various devices, such as a server or a server cluster.

Application scenarios of the embodiments of the present disclosure are described below.

A method for explaining a model provided by the embodiments of the present disclosure may be configured to explain an input sample of a data analysis model, so as to acquire the importance of each feature in the input sample to an output of the data analysis model.

The data analysis model may be a neural network model, and the neural network model is a black-box model that is complicated in structure and may be high in accuracy. At the same time, it is difficult to understand the internal working mechanism of the neural network model, and it is also difficult to estimate the importance of each feature to a prediction result of the model, let alone understanding the interaction between different features.

Specifically, the data analysis model may be configured to analyze a sample of an object to output a prediction result of the sample or a classification result of the sample. In an exemplary embodiment, the data analysis model may be configured to analyze a tabular data set.

The tabular data set is a kind of data composed of multiple rows and columns, in which each row of data is called a sample or an instance, and each column of data is called a feature. Exemplarily, in a tabular data set representing customers of a bank, each row includes a plurality of features of one customer, which may include a customer identification number (ID), customer age, customer occupation, whether there is any default record, average annual account balance, communication duration of the last contact, and the like. The data analysis model may output a prediction result or a classification result of the customer based on the sample, for example, it may output a prediction result for the likelihood of the customer purchasing a bank-related product, or output a classification result for the customer as a customer who will purchase the bank-related product, or for the customer as a customer who will not purchase the bank-related product. In addition, the data analysis model may also be configured to perform other tasks, which is not limited in the embodiments of the present disclosure.

The method for explaining the model provided by the embodiments of the present disclosure may explain an input sample of the data analysis model described above, so as to acquire the importance of each feature of the customer to the output of the data analysis model. The importance may be expressed in the form of a weight. The higher the weight is, the greater the influence of the feature is on the output of the data analysis model; and the lower the weight is, the less the influence of the feature is on the output of the data analysis model. Upon acquisition of the weight of each feature, on the one hand, a user using the data analysis model can better understand the data analysis model, and it is convenient for the user to introduce and explain the data analysis model to other people; on the other hand, the data analysis model can be further optimized based on the explanation result to improve the accuracy of the data analysis model.

In the related art, a perturbation data set is acquired in an original feature space of a to-be-explained sample, and an explanation result is acquired by performing relevant steps accordingly. The explanation result may have poor stability. For example, for the same to-be-explained sample, the explanation results may not be the same when multiple explanations are made, resulting in low reliability of the method.

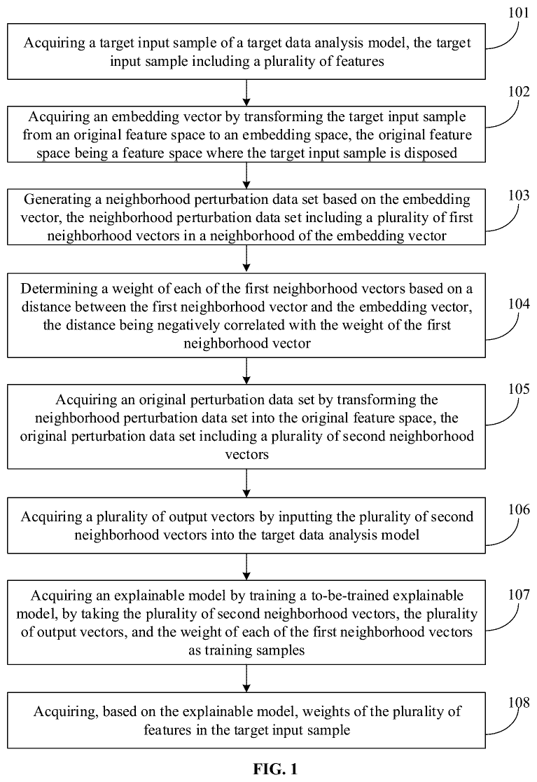

FIG. 1 is a flow chart of a method for explaining a model according to some embodiments of the present disclosure. The method for explaining the model may include the following steps.

In step 101, a target input sample of a target data analysis model is acquired, the target input sample including a plurality of features.

In step 102, an embedding vector is acquired by transforming the target input sample from an original feature space to an embedding space, the original feature space being a feature space where the target input sample is disposed.

In step 103, a neighborhood perturbation data set is generated based on the embedding vector, the neighborhood perturbation data set including a plurality of first neighborhood vectors in a neighborhood of the embedding vector.

In step 104, a weight of each of the first neighborhood vectors is determined based on a distance between the first neighborhood vector and the embedding vector, the distance being negatively correlated with the weight of the first neighborhood vector.

In step 105, an original perturbation data set is acquired by transforming the neighborhood perturbation data set into the original feature space, the original perturbation data set including a plurality of second neighborhood vectors.

In step 106, a plurality of output vectors are acquired by inputting the plurality of second neighborhood vectors into the target data analysis model.

In step 107, an explainable model is acquired by training a to-be-trained explainable model, by taking the plurality of second neighborhood vectors, the plurality of output vectors, and the weight of each of the first neighborhood vectors as training samples.

In step 108, weights of the plurality of features in the target input sample are acquired based on the explainable model.

In summary, in the method for explaining the model according to the embodiments of the present disclosure, the target input sample is transformed from the original feature space to the embedding space, the perturbation data set is generated in the embedding space, and the weights of the neighborhood vectors in the perturbation data set are acquired. After that, the perturbation data set can be transformed back to the original feature space, the explainable model of the target data analysis model can be acquired by training based on the acquired data, and an explanation result can be acquired based on the explainable model. By establishing the explainable model related to the to-be-explained data analysis model, the method can explain a black-box model that is complicated in structure, which solves the problem of low practicability of a method for explaining a model in the related art, and achieves the effect of improving the practicability of the method for explaining the model.

Further, in a method for explaining a model, a perturbation data set is acquired in an original feature space of a to-be-explained sample, and an explanation result is acquired by performing relevant steps accordingly. The explanation result may have poor stability. For example, for the same to-be-explained sample, the explanation results may not be the same when multiple explanations are made, resulting in low reliability of the method.

However, in the present disclosure, the perturbation data set is generated in the embedding space, the weights are acquired correspondingly, and the perturbation data set is then transformed into the original feature space to train the explainable model. Since the embedding space can resist randomness of perturbation, the method can solve the problem of poor stability in the related art and achieve the effect of improving the stability of the method for explaining the model.

It should be noted that the method for explaining the model according to the embodiments of the present disclosure adopts multiple technical means using the natural law: “acquiring an embedding vector by transforming the target input sample from an original feature space to an embedding space,” “generating a neighborhood perturbation data set based on the embedding vector,” “determining a weight of each of the first neighborhood vectors based on the distance between the first neighborhood vector and the embedding vector,” “acquiring an original perturbation data set by transforming the neighborhood perturbation data set into the original feature space,” “acquiring a plurality of output vectors by inputting the plurality of second neighborhood vectors into the target data analysis model,” “acquiring an explainable model by training a to-be-trained explainable model, by taking the plurality of second neighborhood vectors, the plurality of output vectors, and the weight of each of the first neighborhood vectors as training samples,” and “acquiring, based on the explainable model, weights of the plurality of features in the target input sample”, which solves the technical problem of poor stability in the related art and achieves the technical effect of improving the stability of the acquired explanation result.

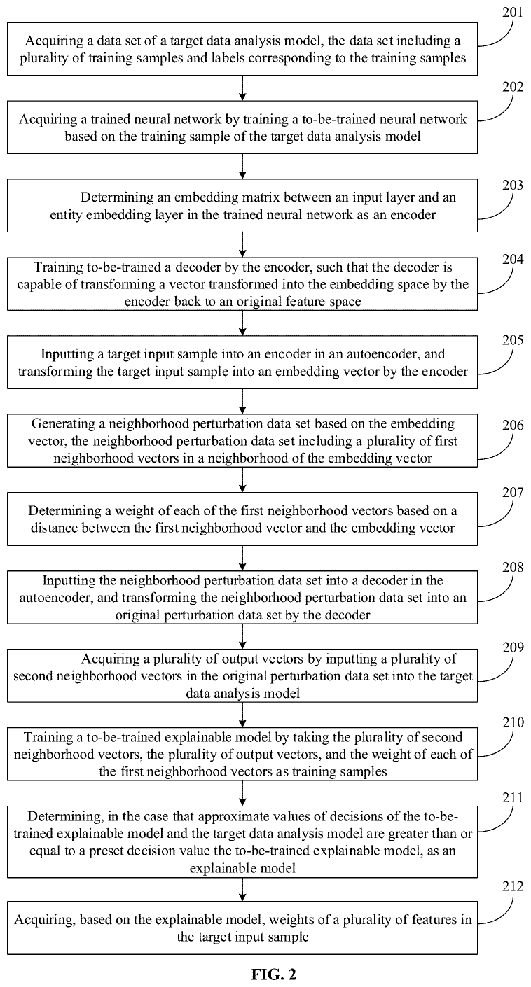

FIG. 2 is a flow chart of another method for explaining a model according to some embodiments of the present disclosure. The method for explaining the model may include the following steps.

In step 201, a data set of a target data analysis model is acquired, the data set including a plurality of training samples and labels corresponding to the training samples.

The method for explaining the model according to the embodiments of the present disclosure may be applied to a server to explain one target input sample of the target data analysis model, so as to acquire an explanation result of the target input sample. The target input sample includes a plurality of features of an object. The target data analysis model is a prediction model for the object, or the target data analysis model is a classification model for the object. In an exemplary embodiment, the object may include a user, an animal, or an item. Exemplarily, in the case that the object is a user, the features of the object may include occupation, age, preference, and the like; in the case that the object is an animal, the features may include species, age, body length, coat color, and the like; and in the case that the object is an item, the features may include price, purchase channel, size, item type, and the like.

The server may include one server or a server cluster.

In applying the method provided by the embodiments of the present disclosure, the server may acquire a data set of a target data analysis model, the data set including a plurality of training samples and labels corresponding to the training samples. The training sample may be a sample for training the target data analysis model, while the label may be a true value corresponding to the training sample. Exemplarily, the training sample may include a plurality of features of a certain customer of a bank on record, while the label may be a record as to whether the customer has purchased a product of the bank on record.

In step 202, a trained neural network is acquired by training a to-be-trained neural network based on the training sample of the target data analysis model.

The to-be-trained neural network includes an input layer and an entity embedding layer connected to the input layer. Further, the neural network may include some other hierarchical structures, such that the neural network can work normally.

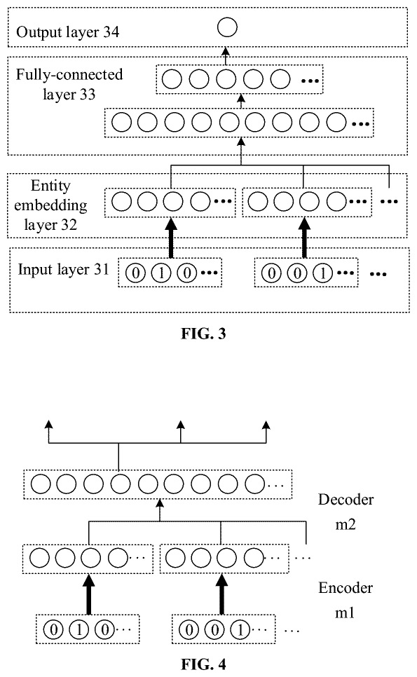

Exemplarily, referring to FIG. 3, which is a schematic structural diagram of a to-be-trained neural network according to some embodiments of the present disclosure, the neural network includes an input layer 31, an entity embedding layer 32, a plurality of fully connected layers 33, and an output layer 34 which are connected in sequence. There may be an embedding matrix between the input layer 31 and the entity embedding layer 32, and the embedding matrix may be configured to transform a vector in an original feature space into an embedding vector in an embedding space. In the case that the plurality of features in the training sample include a non-numerical feature, the non-numerical feature may be transformed into a one-hot code, and the numerical feature may be normalized. A reference may be made to the related art for the way of transformation, which is not limited in the embodiments of the present disclosure. The one-hot code is also known as one-bit effective code, and is used in machine learning to process discrete discontinuous features into continuous ones.

In the case that the to-be-trained neural network is trained, the embedding matrix may be trained together with the neural network. Exemplarily, the process of transforming the vector in the original feature space into the embedding vector in the embedding space may be expressed as:

$${e}_{i} = {W}_{embed , i} \cdot {x}_{i}$$

wherein eᵢ is the embedding vector, xᵢ is the i^{th} feature, W_{embed,i}∈ [symbol] ⁿ^{ₑ}^{×n}^{ᵥ}, W_{embed,i} is the embedding matrix and may be optimized together with other features in the network, nₑ and nᵥ are an embedding scale and a category vocabulary scale that are preset, and [symbol] represents a real number.

The embedding matrix may be configured to transform an input feature into a real-valued dense feature.

The to-be-trained neural network may be a conventional neural network with an entity embedding layer in the art. Exemplarily, the target data analysis model may be used as a basic framework, and the to-be-trained neural network may be acquired by adding the input layer and the entity embedding layer before the target data analysis model.

In step 203, an embedding matrix between the input layer and the entity embedding layer in the trained neural network is determined as an encoder.

Upon completion of training, the server may determine the embedding matrix between the input layer and the entity embedding layer in the trained neural network as the encoder. In the case that the neural network meets a preset training completion condition, the server may determine that training of the neural network is completed.

The embedding matrix between the input layer and the entity embedding layer in the trained neural network may be determined as the encoder after training of the neural network is completed.

In step 204, a to-be-trained decoder is trained by the encoder, such that the decoder is capable of transforming a vector transformed into the embedding space by the encoder back to the original feature space.

The decoder may be a decoder compatible with the encoder acquired in step 203. The decoder is capable of transforming the vector transformed by the encoder into the embedding space back to the original feature space, which may mean that for a certain sample, after the sample is input into the encoder, an output of the encoder is input into the decoder, and an output of the decoder is the same as or similar enough to the sample.

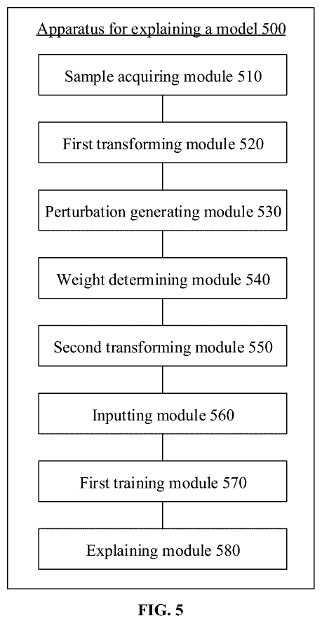

As shown in FIG. 4, which is a schematic structural diagram of an encoder and a decoder according to some embodiments of the present disclosure, in the case that a to-be-trained decoder m2 is trained by an encoder m1, the training sample of the target data analysis model described above may be input into the encoder m1, then an output of the encoder m1 may be input into the decoder m2, and after that, an output of the decoder m2 may be compared with the training sample. In the case that the difference between the output of the decoder m2 and the training sample is greater than a specified value, the decoder is adjusted based on the difference between the output of the decoder m2 and the training sample; and in the case that the difference between the output of the decoder m2 and the training sample is less than or equal to the specified value, it indicates that training of the decoder m2 is completed.

Before training of the decoder, the encoder may be marked as untrainable, and only the decoder is trained.

The trained encoder and decoder may form an autoencoder. The autoencoder is a neural network capable of compressing high-dimensional data into a latent representation.

In step 205, the target input sample is input into the encoder in the autoencoder, and the target input sample is transformed into the embedding vector by the encoder.

Upon acquisition of the autoencoder, the server may input the the target input sample into the encoder in the autoencoder, and the target input sample is transformed into the embedding vector by the encoder. The target input sample may be an input sample of the data analysis model, and the target input sample may be specified by the user.

It should be noted that before step 205, in the case that the training samples in the data set of the target data analysis model include a non-numerical feature, the non-numerical feature is transformed into a one-hot code.

In step 206, a neighborhood perturbation data set is generated based on the embedding vector, the neighborhood perturbation data set including a plurality of first neighborhood vectors in a neighborhood of the embedding vector.

The process of generating the perturbation data set of the embedding vector may be a process of data perturbation. Exemplarily, in the case that data perturbation is performed on an embedding vector x, values of some features in x may be slightly changed to generate another different sample x′, the distance between x and x′ is very short in space, and the distance may be preliminarily limited. In this way, the server may acquire a plurality of first neighborhood vectors of the embedding vector.

In step 207, a weight of each of the first neighborhood vectors is determined based on the distance between the first neighborhood vector and the embedding vector.

The server may determine the distance between each of the first neighborhood vectors and the embedding vector, and determine the weight of each of the first neighborhood vectors based on the distance, the distance being negatively correlated with the weight of the first neighborhood vector.

The distance between the first neighborhood vector and the embedding vector may be Euclidean distance. Since the server calculates the distance between the first neighborhood vector and the embedding vector in the embedding space, the distance is more stable and less random.

In step 208, the neighborhood perturbation data set is input into a decoder in the autoencoder, and the neighborhood perturbation data set is transformed into the original perturbation data set by the decoder.

The server may input the neighborhood perturbation data set into the decoder in the autoencoder, and transform the neighborhood perturbation data set into the original perturbation data set by the decoder, the original perturbation data set including a plurality of second neighborhood vectors.

The encoder may transform the first neighborhood vector in each embedding space of the neighborhood perturbation data set into the second neighborhood vector in the original feature space.

In step 209, a plurality of output vectors are acquired by inputting the plurality of second neighborhood vectors in the original perturbation data set into the target data analysis model.

The server may input the plurality of second neighborhood vectors in the original disturbance data set into the target data analysis model, and the target data analysis model may output a plurality of output vectors based on the plurality of second neighborhood vectors in the original feature space.

In step 210, a to-be-trained explainable model is trained by taking the plurality of second neighborhood vectors, the plurality of output vectors, and the weight of each of the first neighborhood vectors as training samples.

The server may train the to-be-trained explainable model by taking the plurality of second neighborhood vectors, the plurality of output vectors, and the weight of each of the first neighborhood vectors as training samples.

The to-be-trained explainable model may be one of a linear model, a decision-making tree, or a descent rule list model. In the embodiments of the present disclosure, the to-be-trained explainable model may be a linear ridge regression model of linear models.

The process of training the to-be-trained explainable model may be expressed as:

$$explanation ( x ) = arg {min}_{g ∈ G} ( L ( f , g , {π}_{x} ) + Ω ( g ) ) ,$$

wherein explanation(x) is an explanation result of the to-be-trained explainable model, x is the target input sample, πₓ is a proximity index in a neighborhood of x, and G represents all possible explainable models (such as linear models) in a selected model space, g is the to-be-trained explainable model, Ω(g) is an evaluation index of model complexity, and f is the target data analysis model. The lower the model complexity is, the smaller the value of Ω(g) is. L(f,g,πₓ) describes the degree of approximation of the to-be-trained explainable model g to a decision of the target data analysis model f near the target input sample. The more approximate of the decisions of g and f is, the smaller the value of L is. It can be seen from the above formula that an objective of training the explainable model is to narrow the gap between the output of the explainable model and the output of the target data analysis model as far as possible in the face of the same input sample, and at the same time, the training process prefers the explainable model with low complexity. Moreover, the user can preset the maximum complexity of the model, and the complexity of the explainable model acquired by training cannot exceed the preset maximum complexity.

In step 211, in the case that approximate values of decisions of the to-be-trained explainable model and the target data analysis model are greater than or equal to a preset decision value, the to-be-trained explainable model is determined as the explainable model.

A determination can be made in various ways as to whether the approximate values of the decisions of the to-be-trained explainable model and the target data analysis model are greater than or equal to the preset decision value. Exemplarily, it can be known from step 210 that the server, when training the to-be-trained explainable model, may narrow the gap between the output of the explainable model and the output of the target data analysis model in the face of the perturbation data set generated by the same input sample within the preset model complexity. Further, when the weighted sum of loss values of the to-be-trained explainable model and the target data analysis model for the same perturbation data set and the sum of the complexity evaluation values of the explainable model is minimized (this effect can be achieved by a training tool of a model), and the model complexity of the to-be-trained explainable model is less than the preset model complexity, the server may determine that the approximate values of the decisions of the to-be-trained explainable model and the target data analysis model are greater than or equal to the preset decision value, and that the training is completed, and determine the to-be-trained explainable model as the explainable model.

In step 212, weights of the plurality of features in the target input sample are acquired based on the explainable model.

Upon completion of training of the explainable model, since the explainable model is simple in structure and easy to understand, the weights of the plurality of features in the target input sample may be acquired based on the explainable model. According to different types of the explainable models, the weights of the plurality of features in the target input samples may be acquired in different ways based on the explainable models. Exemplarily, when the explainable model is a linear model, coefficients of a plurality of features in the explainable model are acquired, and the coefficients of the plurality of features are determined as the weights of the plurality of features. The weights of the features are the explanation result of the data analysis model for the target input sample in the method provided by the embodiments of the present disclosure, and different explanation results may be acquired for different input samples.

In practice, both numerical features and non-numerical features always simultaneously appear in business data (the business data may include a plurality of input samples) that needs to be processed by the data analysis model, and only processing the numerical features is greatly limited. In the present disclosure, the embedding space is introduced and a high-quality neighborhood is generated for the non-numerical features, such that the business data with both of the numerical features and the non-numerical features can be well processed.

In summary, in the method for explaining the model according to the embodiments of the present disclosure, the target input sample is transformed from the original feature space to the embedding space, the perturbation data set is generated in the embedding space, and the weights of the neighborhood vectors in the perturbation data set are acquired. After that, the perturbation data set may be transformed back to the original feature space, the explainable model of the target data analysis model can be acquired by training based on the acquired data, and an explanation result can be acquired based on the explainable model. By establishing one explainable model related to the to-be-explained data analysis model, the method can explain a black-box model that is complicated in structure, which solves the problem of low practicability of a method for explaining a model in the related art, and achieves the effect of improving the practicability of the method for explaining the model.

In addition, in the present disclosure, the perturbation data set is generated in the embedding space, the weights are acquired correspondingly, and the perturbation data set is then transformed into the original feature space to train the explainable model. Since the embedding space can resist randomness of perturbation, the method can solve the problem of poor stability in the related art and achieve the effect of improving the stability of the method for explaining the model.

In a specific example, the target data analysis model is a model for predicting whether a customer will subscribe to the bank's time deposit business. This task is a classification task, and the output labels are “yes” and “no”. The features of the customer include customer ID, customer age, customer occupation, whether there is any default record, average annual account balance, communication duration of the last contact, etc., in which category features include customer occupation (valued as admin, technician, services, blue-collar, etc.), whether there is any default record (yes and no), etc., and numerical features may include communication duration of the last contact (valued as integer minutes), etc. For processing of the category features, taking customer occupation as an example, in the case that there are 10 values of customer occupation, its corresponding one-hot code is a 10-dimensional feature, and each dimension corresponds to one occupation. In the case that a first dimension represents admin and a second dimension represents technician . . . . Exemplarily, in the case that the customer's occupation is technician, the customer's “customer occupation” is expressed as [0,1,0,0,0,0,0,0,0], which corresponds to the input layer in FIG. 3. The embedding layer transforms the one-hot code into a real-valued dense feature, for example, transforms [0,1,0,0,0,0,0,0,0,0,0,0] into [0.6,0.2,0.4,0.2].

In the case that the prediction result of the target data analysis model is “Yes” for a certain customer, a bank clerk wants to know the reason why the model believes that the customer will subscribe. The method for explaining the model according to the embodiments of the present disclosure may provide explanations in the following forms: customer occupation 0.5, average annual account balance 0.3, communication duration of the last contact 0.2. The corresponding intuitive explanation is: the target data analysis model believes that the customer will subscribe to bank business, and the feature most valued by the model is customer occupation, with an importance percentage of 0.5; the second most important feature is average annual account balance, with an importance percentage of 0.3; the third most important feature is communication duration of the last contact, with an importance percentage of 0.2; and other features do not play a decisive role.

The followings are apparatus embodiments of the present disclosure, which can be used to perform the method embodiments of the present disclosure. For details not disclosed in the apparatus embodiments of the present disclosure, a reference may be made to the method embodiments of the present disclosure.

FIG. 5 is a block diagram of an apparatus for explaining a model according to some embodiments of the present disclosure, the apparatus 500 for explaining the model includes:
a sample acquiring module 510, configured to acquire a target input sample of a target data analysis model, the target input sample including a plurality of features;
a first transforming module 520, configured to acquire an embedding vector by transforming the target input sample from an original feature space to an embedding space, the original feature space being a feature space where the target input sample is disposed;
a perturbation generating module 530, configured to generate a neighborhood perturbation data set based on the embedding vector, the neighborhood perturbation data set including a plurality of first neighborhood vectors in a neighborhood of the embedding vector;
a weight determining module 540, configured to determine a weight of each of the first neighborhood vectors based on the distance between the first neighborhood vector and the embedding vector, the distance being negatively correlated with the weight of the first neighborhood vector;
a second transforming module 550, configured to acquire an original perturbation data set by transforming the neighborhood perturbation data set into the original feature space, the original perturbation data set including a plurality of second neighborhood vectors;
an inputting module 560, configured to acquire a plurality of output vectors by inputting the plurality of second neighborhood vectors into the target data analysis model;
a first training module 570, configured to acquire an explainable model by training a to-be-trained explainable model, by taking the plurality of second neighborhood vectors, the plurality of output vectors and the weight of each of the first neighborhood vectors as training samples; and
an explaining module 580, configured to acquire, based on the explainable model, weights of the plurality of features in the target input sample of the target data analysis model.

In summary, in the apparatus for explaining the model according to the embodiments of the present disclosure, the target input sample is transformed from the original feature space to the embedding space, the perturbation data set is generated in the embedding space, and the weights of the neighborhood vectors in the perturbation data set are acquired. After that, the perturbation data set can be transformed back to the original feature space, the explainable model of the target data analysis model can be acquired by training based on the acquired data, and an explanation result can be acquired based on the explainable model. By establishing one explainable model related to the to-be-explained data analysis model, the method can explain a black-box model that is complicated in structure, which solves the problem of low practicability of a method for explaining a model in the related art, and achieves the effect of improving the practicability of the method for explaining the model.

In addition, in the present disclosure, the perturbation data set is generated in the embedding space, the weights are acquired correspondingly, and the perturbation data set is then transformed into the original feature space to train the explainable model. Since the embedding space can resist randomness of perturbation, the method can solve the problem of poor stability in the related art and achieve the effect of improving the stability of the method for explaining the model.

Optionally, the first transforming module is configured to input the target input sample into an encoder in an autoencoder, and transform the target input sample into the embedding vector by the encoder; and
the second transforming module is configured to input the neighborhood perturbation data set into a decoder in the autoencoder, and transform the neighborhood perturbation data set into the original perturbation data set by the decoder.

Optionally, the apparatus for explaining the model further includes:
a data set acquiring module, configured to acquire a data set of the target data analysis model, the data set including a plurality of training samples and labels corresponding to the training samples;
a second training module, configured to acquire a trained neural network by training, based on the training sample of the target data analysis model, a to-be-trained neural network, the to-be-trained neural network including an input layer and an entity embedding layer connected to the input layer; and
an encoder determining module, configured to determine an embedding matrix between the input layer and the entity embedding layer in the trained neural network as the encoder.

In summary, in the apparatus for explaining the model according to the embodiments of the present disclosure, the target input sample is transformed from the original feature space to the embedding space, the perturbation data set is generated in the embedding space, and the weights of the neighborhood vectors in the perturbation data set are acquired. After that, the perturbation data set can be transformed back to the original feature space, the explainable model of the target data analysis model can be acquired by training based on the acquired data, and an explanation result can be acquired based on the explainable model. By establishing one explainable model related to the to-be-explained data analysis model, the method can explain a black-box model that is complicated in structure, which solves the problem of low practicability of a method for explaining a model in the related art, and achieves the effect of improving the practicability of the method for explaining the model.

In addition, in the present disclosure, the perturbation data set is generated in the embedding space, the weights are acquired correspondingly, and the perturbation data set is then transformed into the original feature space to train the explainable model. Since the embedding space can resist randomness of perturbation, the method can solve the problem of poor stability in the related art and achieve the effect of improving the stability of the method for explaining the model.

Furthermore, an embodiment of the present disclosure further provides a device for explaining a model. The device for explaining the model includes a processor and a memory storing at least one instruction, at least one program, a code set, or an instruction set, wherein the at least one instruction, the at least one program, the code set, or the instruction set, when loaded and executed by the processor, causes the processor to perform the method for explaining the model described above.

An embodiment of the present disclosure further provides a computer storage medium. The computer storage medium stores at least one instruction, at least one program, a code set, or an instruction set, wherein the at least one instruction, the at least one program, the code set, or the instruction set, when loaded and executed by a processor, causes the processor to perform the method for explaining the model described above.

An embodiment of the present disclosure further provides a computer program product or a computer program. The computer program product or the computer program includes at least one computer instruction, the at least one computer instruction being stored in a computer-readable storage medium. A processor of a computer device reads the at least one computer instruction from the computer-readable storage medium, and the processor executes the at least one computer instruction to cause the computer device to perform the method for explaining the model described above

In the present disclosure, the terms “first” and “second” are used for descriptive purposes only and are not to be construed as indicating or implying relative importance. The term “a plurality of” refers to two or more, unless specifically defined otherwise.

In several embodiments provided by the present disclosure, it should be understood that the disclosed apparatus and method may be implemented by other means. For example, the apparatus embodiments described above are merely schematic. For example, the partitioning of the units may be a logical functional partitioning. There may be other partitioning modes during actual implementation. For example, a plurality of units or components may be combined or integrated into another system, or some features may be ignored or not executed. In addition, the coupling or direct coupling or communication connection shown or discussed may be indirect coupling or communication connection through some interfaces, apparatuses or units, which may be in electrical, mechanical or other forms.

The units described as separate components may or may not be physically separate, and the components displayed as units may or may not be physical units, i.e., may be located at one place, or may be distributed to multiple network modules. Some or all of the units may be selected according to actual needs to achieve the purpose of the embodiment solutions.

Those of ordinary skill in the art can understand that all or part of the steps in the above embodiments may be completed through hardware, or through relevant hardware instructed by a program stored in a computer-readable storage medium, such as a read-only memory, a disk, or an optical disc.

The above descriptions are only optional embodiments of the present disclosure, and are not intended to limit the present disclosure. Any modifications, equivalent substitutions, improvements, and the like made within the spirit and principles of the present disclosure should be included within the scope of protection of the present disclosure.

1. A method for explaining a model, comprising:
acquiring a target input sample of a target data analysis model, the target input sample comprising a plurality of features;
acquiring an embedding vector by transforming the target input sample from an original feature space to an embedding space, the original feature space being a feature space where the target input sample is disposed;
generating a neighborhood perturbation data set based on the embedding vector, the neighborhood perturbation data set comprising a plurality of first neighborhood vectors in a neighborhood of the embedding vector;
determining a weight of each of the first neighborhood vectors based on a distance between the first neighborhood vector and the embedding vector, the distance being negatively correlated with the weight of the first neighborhood vector;
acquiring an original perturbation data set by transforming the neighborhood perturbation data set into the original feature space, the original perturbation data set comprising a plurality of second neighborhood vectors;
acquiring a plurality of output vectors by inputting the plurality of second neighborhood vectors into the target data analysis model;
acquiring an explainable model by training a to-be-trained explainable model, by taking the plurality of second neighborhood vectors, the plurality of output vectors, and the weight of each of the first neighborhood vectors as training samples; and
acquiring, based on the explainable model, weights of the plurality of features in the target input sample.

2. The method for explaining the model according to claim 1, wherein acquiring the embedding vector by transforming the target input sample from the original feature space to the embedding space comprises:
inputting the target input sample into an encoder in an autoencoder, and transforming the target input sample into the embedding vector by the encoder, wherein the autoencoder comprises the encoder and a decoder.

3. The method for explaining the model according to claim 2, wherein acquiring the original perturbation data set by transforming the neighborhood perturbation data set into the original feature space comprises:
inputting the neighborhood perturbation data set into the decoder in the autoencoder, and transforming the neighborhood perturbation data set into the original perturbation data set by the decoder.

4. The method for explaining the model according to claim 3, wherein prior to inputting the target input sample into the encoder in the autoencoder, and transforming the target input sample into the embedding vector by the encoder, the method further comprises:
acquiring a data set of the target data analysis model, the data set comprising a plurality of training samples and labels corresponding to the training samples;
acquiring a trained neural network by training, based on the training sample of the target data analysis model, a to-be-trained neural network, the to-be-trained neural network comprising an input layer and an entity embedding layer connected to the input layer; and
determining an embedding matrix between the input layer and the entity embedding layer in the trained neural network as the encoder.

5. The method for explaining the model according to claim 4, wherein the embedding matrix is configured to transform an input feature into a real-valued dense feature.

6. The method for explaining the model according to claim 4, wherein upon determining the embedding matrix between the input layer and the entity embedding layer in the trained neural network as the encoder, the method further comprises:
training, by the encoder, a to-be-trained decoder, such that the decoder is capable of transforming a vector transformed into the embedding space by the encoder back to the original feature space.

7. The method for explaining the model according to claim 4, wherein prior to acquiring the trained neural network by training, based on the training sample of the target data analysis model, the to-be-trained neural network, the method further comprises:
transforming, in a case that the training sample in the data set of the target data analysis model comprises a non-numerical feature, the non-numerical feature into a one-hot code.

8. The method for explaining the model according to claim 1, wherein the explainable model is one of a linear model, a decision-making tree, or a descent rule list model.

9. The method for explaining the model according to claim 8, wherein acquiring, based on the explainable model, the weights of the plurality of features in the target input sample comprises:
acquiring, in a case that the explainable model is a linear model, coefficients of a plurality of features in the explainable model; and
determining the coefficients of the plurality of features as weights of the plurality of features.

10. The method for explaining the model according to claim 1, wherein acquiring the explainable model by training the to-be-trained explainable model, by taking the plurality of second neighborhood vectors, the plurality of output vectors, and the weight of each of the first neighborhood vectors as the training samples, comprises:
training the to-be-trained explainable model, by taking the plurality of second neighborhood vectors, the plurality of output vectors, and the weight of each of the first neighborhood vectors as training samples; and
determining, in a case that approximate values of decisions of the to-be-trained explainable model and the target data analysis model are greater than or equal to a preset decision value, the to-be-trained explainable model as the explainable model.

11. The method for explaining the model according to claim 1, wherein upon acquiring, based on the explainable model, the weights of the plurality of features in the target input sample, the method further comprises:
optimizing the target data analysis model based on the weights of the plurality of features.

12. The method for explaining the model according to claim 1, wherein the target input sample comprises a plurality of features of an object; and
the target data analysis model is a prediction model for the object, or the target data analysis model is a classification model for the object.

13. The method for explaining the model according to claim 12, wherein the object comprises a user, an animal, or an item.

14. An apparatus for explaining a model, comprising:
a processor; and
a memory configured to store one or more instructions executable by the processor;
wherein the processor, when loading and executing the one or more instructions, is caused to perform:
acquiring a target input sample of a target data analysis model, the target input sample comprising a plurality of features;
acquiring an embedding vector by transforming the target input sample from an original feature space to an embedding space, the original feature space being a feature space where the target input sample is disposed;
generating a neighborhood perturbation data set based on the embedding vector, the neighborhood perturbation data set comprising a plurality of first neighborhood vectors in a neighborhood of the embedding vector;
determining a weight of each of the first neighborhood vectors based on a distance between the first neighborhood vector and the embedding vector, the distance being negatively correlated with the weight of the first neighborhood vector;
acquiring an original perturbation data set by transforming the neighborhood perturbation data set into the original feature space, the original perturbation data set comprising a plurality of second neighborhood vectors;
acquiring a plurality of output vectors by inputting the plurality of second neighborhood vectors into the target data analysis model;
acquiring an explainable model by training a to-be-trained explainable model, by taking the plurality of second neighborhood vectors, the plurality of output vectors, and the weight of each of the first neighborhood vectors as training samples; and
acquiring, based on the explainable model, weights of the plurality of features in the target input sample.

15. The apparatus for explaining the model according to claim 14, wherein the processor, when loading and executing the one or more instructions, is caused to perform:
inputting the target input sample into an encoder in an autoencoder, and transforming the target input sample into the embedding vector by the encoder, wherein the autoencoder comprises the encoder and a decoder; and
inputting the neighborhood perturbation data set into the decoder in the autoencoder, and transforming the neighborhood perturbation data set into the original perturbation data set by the decoder.

16. The apparatus for explaining the model according to claim 15, wherein the processor, when loading and executing the one or more instructions, is caused to perform:
acquiring a data set of the target data analysis model, the data set comprising a plurality of training samples and labels corresponding to the training samples;
acquiring a trained neural network by training, based on the training sample of the target data analysis model, a to-be-trained neural network, the to-be-trained neural network comprising an input layer and an entity embedding layer connected to the input layer; and
determining an embedding matrix between the input layer and the entity embedding layer in the trained neural network as the encoder.

17. (canceled)

18. A non-transient computer storage medium storing at least one instruction, at least one program, a code set, or an instruction set, wherein the at least one instruction, the at least one program, the code set, or the instruction set, when loaded and executed by a processor, causes the processor to perform a method for explaining the model comprising:
acquiring a target input sample of a target data analysis model, the target input sample comprising a plurality of features;
acquiring an embedding vector by transforming the target input sample from an original feature space to an embedding space, the original feature space being a feature space where the target input sample is disposed;
generating a neighborhood perturbation data set based on the embedding vector, the neighborhood perturbation data set comprising a plurality of first neighborhood vectors in a neighborhood of the embedding vector;
determining a weight of each of the first neighborhood vectors based on a distance between the first neighborhood vector and the embedding vector, the distance being negatively correlated with the weight of the first neighborhood vector;
acquiring an original perturbation data set by transforming the neighborhood perturbation data set into the original feature space, the original perturbation data set comprising a plurality of second neighborhood vectors;
acquiring a plurality of output vectors by inputting the plurality of second neighborhood vectors into the target data analysis model;
acquiring an explainable model by training a to-be-trained explainable model, by taking the plurality of second neighborhood vectors, the plurality of output vectors, and the weight of each of the first neighborhood vectors as training samples; and
acquiring, based on the explainable model, weights of the plurality of features in the target input sample of the target data analysis model.

19. The apparatus for explaining the model according to claim 16, wherein the processor, when loading and executing the one or more instructions, is caused to perform:
training, by the encoder, a to-be-trained decoder, such that the decoder is capable of transforming a vector transformed into the embedding space by the encoder back to the original feature space.

20. The apparatus for explaining the model according to claim 16, wherein the processor, when loading and executing the one or more instructions, is caused to perform:
transforming, in a case that the training sample in the data set of the target data analysis model comprises a non-numerical feature, the non-numerical feature into a one-hot code.

21. The non-transient computer storage medium according to claim 18, wherein the at least one instruction, the at least one program, the code set, or the instruction set, when loaded and executed by a processor, causes the processor to perform:
inputting the target input sample into an encoder in an autoencoder, and transforming the target input sample into the embedding vector by the encoder, wherein the autoencoder comprises the encoder and a decoder.
